(19) United States
(12) Patent Application Publication
(10) Pub. No.: US 2015/0075469 A1
(43) Pub. Date: Mar. 19, 2015

(54) OHV ENGINE

(71) Applicant: YAMAHA MOTOR POWER PRODUCTS KABUSHIKI KAISHA, Kakegawa-shi (JP)

(72) Inventor: Atsushi SUZUKI, Shizuoka (JP)

(21) Appl. No.: 14/484,466

(22) Filed: Sep. 12, 2014

(30) Foreign Application Priority Data
Sep. 13, 2013 (JP) 2013-191201

(51) Int. Cl. F01L 1/047; F02F 7/00; F02B 63/04

(52) U.S. Cl. CPC F01L 1/047; F02B 63/048; F02F 7/0019; F02F 7/0043
USPC 123/90.31; 123/90.6

(57) ABSTRACT

An OHV engine with a reduced height includes a cylinder, a piston inside the cylinder, a crank shaft that converts reciprocating movement of the piston into rotating movement, a connecting rod that connects the piston and the crank shaft to each other, and a cam shaft that moves in association with the crank shaft. When the cylinder is viewed from the crank shaft, the cylinder is inclined in an obliquely upward direction so that an angle defined by the cylinder center axis and a horizontal plane is greater than 0 degree and smaller than about 45 degrees. The cam shaft is at a lower position than the cylinder center axis. The cylinder center axis is offset with respect to a line which passes through a rotation axis of the crank shaft and is parallel or substantially parallel to the cylinder center axis, to a side spaced away from the cam shaft.

### BACKGROUND OF THE INVENTION

1. Field of the Invention

The present invention relates to Over Head Valve or OHV engines, and more specifically to an OHV engine preferably for use as a utility engine.

2. Description of the Related Art

A utility engine typically has its fuel tank located on an upper region of the engine so as to supply fuel without employing an expensive fuel pump. The higher the location of the fuel tank, the higher the center of gravity of the engine including the fuel tank with the fuel inside it, leading to increased vibration of the engine, limited maneuverability of the equipment mounted with the engine, etc. So, there is a requirement to lower a height of the engine. One idea for achieving this is to tilt cylinders of the engine, but tilting the cylinders will limit mounting dimensions of the cylinders for installation onto the equipment. Therefore, it is also required that engine's horizontal dimensions (width and depth) are also reduced.

In this case, an OHV engine such as disclosed in Japanese Unexamined Utility Model Application Publication No. H3-5909 is advantageous, i.e., an engine in which a cam shaft is disposed below a tilted cylinder helps reducing engine dimensions (height, width and depth).

Recently, however, there is another requirement for increased length of piston stroke for better fuel economy. A longer piston stroke results in a longer cylinder and an increased height of the engine, but it is still desirable to have a short engine height even if the piston stroke is increased.

### SUMMARY OF THE INVENTION

Therefore, preferred embodiments of the present invention provide an OHV engine having a reduced height.

According to an aspect of various preferred embodiments of the present invention, an OHV engine includes a cylinder; a piston inside the cylinder; a crank shaft configured to convert reciprocating movement of the piston into rotating movement; a connecting rod configured to connect the piston and the crank shaft to each other; and a cam shaft configured to move in association with the crank shaft. In this engine, the cylinder is inclined in an obliquely upward direction so that an angle θ1 defined by a cylinder center axis and a horizontal plane preferably is greater than 0 degree and smaller than about 45 degrees, for example, when the cylinder is viewed from the crank shaft; the camshaft is at a lower position than the cylinder center axis; and the cylinder center axis is offset with respect to a line which passes through a rotation axis of the crank shaft and is parallel or substantially parallel to the cylinder center axis, to a side that is spaced away from the cam shaft.

According to various preferred embodiments of the present invention, it is possible to increase a distance between the cylinder and the cam shaft by offsetting the cylinder center axis to the side away from the cam shaft. This means that it is possible to achieve more inclination in the cylinder without changing a distance between the cam shaft and the crank shaft (distance between the cam shaft's rotation axis and the crank shaft's rotation axis) within a range where there is no interference between the cylinder and the camshaft. Consequently, it is possible to lower the height of the engine. Further, the cylinder inclines such that the angle θ1 which is defined by the cylinder center axis and the horizontal plane is greater than 0 degree and smaller than about 45 degrees, for example. Therefore, even when the cylinder is given a longer dimension in the direction of the cylinder center axis, an increase in the height of the engine is smaller than an increase in horizontal dimensions of the engine. As a result, it becomes possible to reduce the height of the engine even if the length of the cylinder is increased.

Preferably, the OHV engine further includes a crank case attached to the cylinder and accommodating the crank shaft and the cam shaft; a drive gear provided around the crank shaft; and a driven gear provided around the cam shaft and rotating in association with rotation of the drive gear. With this arrangement, the cam shaft has its rotation axis at a lower position than a horizontal plane which passes through the rotation axis of the crank shaft; and the horizontal plane and a straight line which connects the rotation axis of the cam shaft and the rotation axis of the crank shaft define an angle θ2 which is greater than 0 degree and smaller than about 45 degrees, for example. When increasing the piston stroke, the crank webs have to have an increased outward form, and therefore the cam shaft must be moved away from the crank shaft in order to prevent interference with the crank webs. This results in an increase in the distance between the rotation axis of the cam shaft and the rotation axis of the crank shaft, and an increase in a diameter (radius) of the cam shaft driven gear, so the camshaft driven gear is dipped in oil inside the crank case to an increased height (depth). If the driven gear is dipped into the oil to an increased height (depth) when splashing the oil, more horse power is lost.

However, if the angle θ2 which is defined by the horizontal plane and the straight line that connects the rotation axis of the cam shaft and the rotation axis of the crank shaft with each other is greater than 0 degree and smaller than about 45 degrees, for example an increase in the vertical distance is smaller than an increase in the horizontal distance even when the distance between the rotation axis of the cam shaft and the rotation axis of the crank shaft is increased. Because of this, and due to the fact that the horizontal plane is parallel or substantially parallel to a surface of the oil, the arrangement makes it possible to significantly reduce or prevent an increase in a surface area of the portion of the driven gear in the cam shaft that is dipped into the oil, and therefore makes it possible to reduce an increase in loss of horse power. In addition, it is also possible to reduce an increase in the height of the engine.

Further preferably, the angle θ1 is greater than the angle θ2. In this case, location of the cam shaft is limited so that the angle θ2 will be smaller than the angle θ1, whereas the rotation axis of the camshaft is disposed at a higher position, i.e., more closely, to the horizontal plane which passes through the rotation axis of the crank shaft. The cam shaft disposed at the higher position makes it possible to increase a distance between the cam shaft and the surface of the oil inside the crank case, which then makes it possible to raise the surface of the oil (more closely to the horizontal plane which passes the rotation axis of the crank shaft). Consequently, it becomes possible to reduce dimensions of the crank case in the up-down direction. As a result, it becomes possible to reduce the dimensions of the engine in the up-down direction, i.e., the height of the engine.

Further, preferably, a rotation direction of the crank shaft is counterclockwise when the OHV engine is viewed from a position where the crank shaft is located on the left side and the cam shaft is located on the right side. Generally in an OHV engine, a maximum combustion pressure is reached slightly after the piston has passed the top dead center. At this point, the combustion pressure in a space surrounded by the cylinder and the piston peaks out, with the piston under an increased thrust force. However, as described above, the cylinder center axis is preferably offset to the side spaced away from the cam shaft and the crank shaft is rotated counterclockwise. This makes it possible to bring the connecting rod (especially a portion thereof which is closer to the crank shaft) closely to the cylinder center axis slightly after the piston has passed the top dead center. Specifically, during the time when the combustion pressure is high, the connecting rod and the cylinder are in a positional relationship which advantageously reduces a thrust force that acts on the piston. This reduces friction which acts on the piston, and thus improves fuel economy.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view from a front left view point, of an engine generator which includes an OHV engine according to a preferred embodiment of the present invention.

FIG. 2 is a perspective view from a rear right view point, of the engine generator which includes the OHV engine according to a preferred embodiment of the present invention.

FIG. 3 is a diagram of the engine, showing a longitudinal section thereof.

FIG. 4 is a graph which shows a relationship between a crank angle and a pressure inside a cylinder of the engine.

FIG. 5A is a diagram for describing a force which acts on a piston if the cylinder is not offset, whereas FIG. 5B is a diagram for describing a force which acts on the piston if the cylinder is offset.

### DETAILED DESCRIPTION OF THE PREFERRED EMBODIMENTS

Hereinafter, preferred embodiments of the present invention will be described with reference to the drawings.

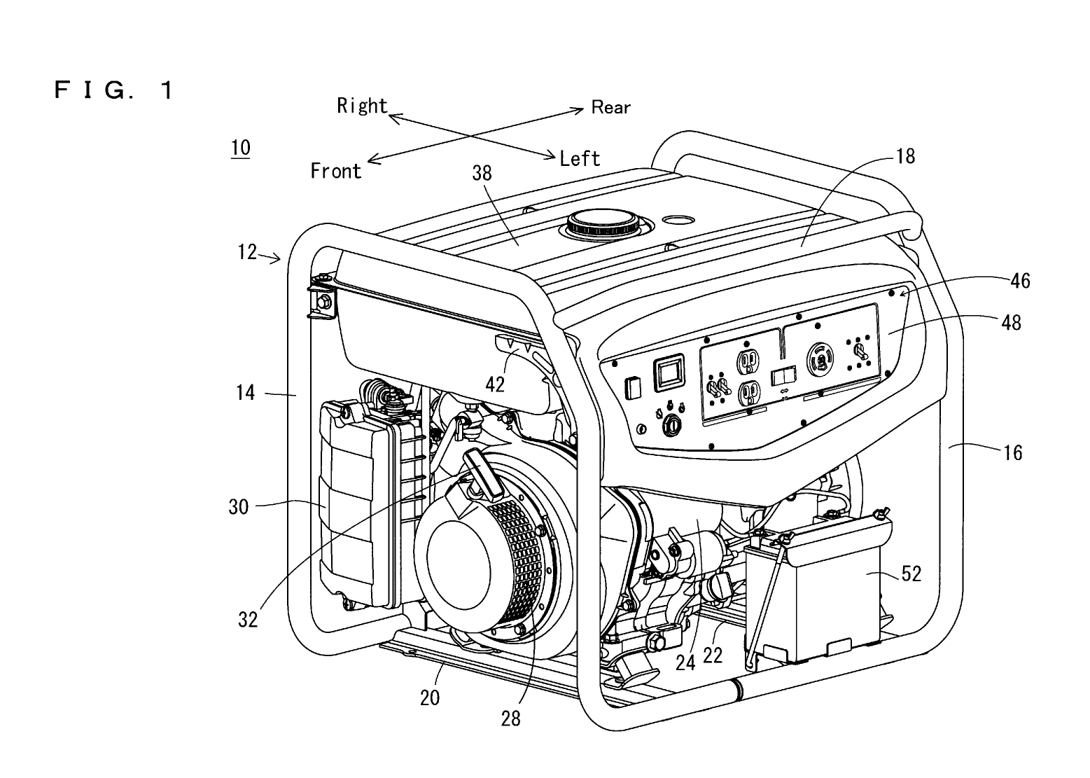

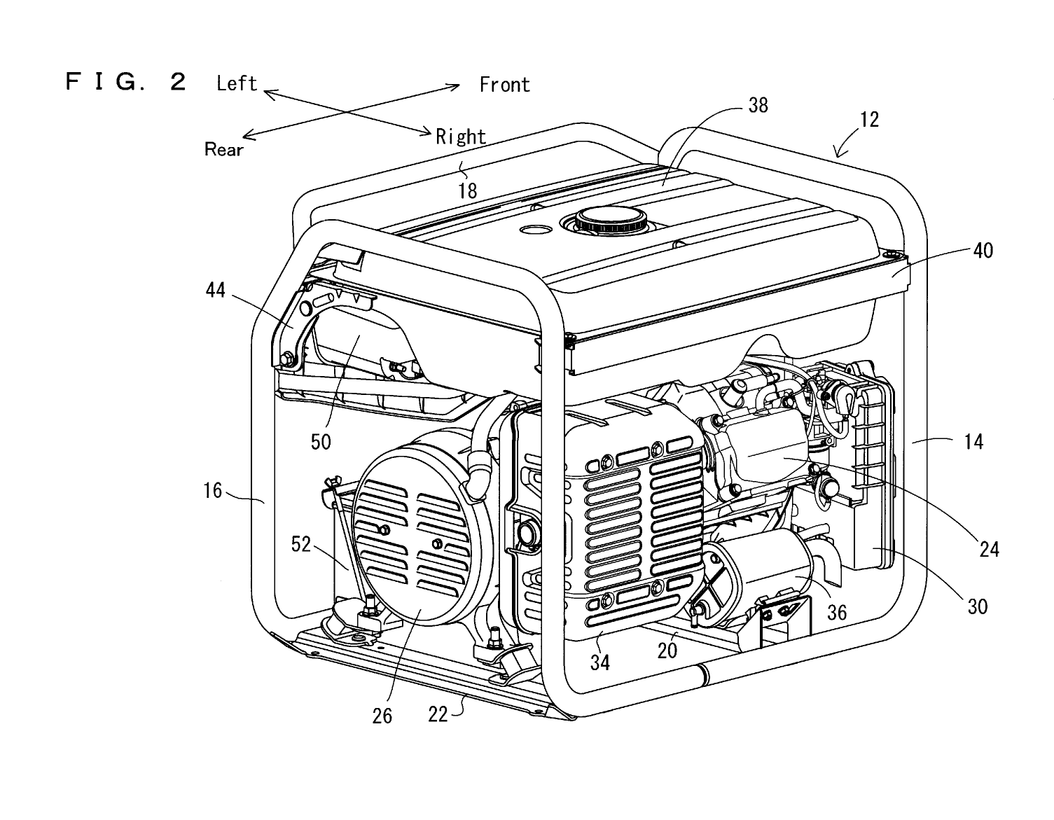

FIG. 1 and FIG. 2 show an engine generator 10 which includes an OHV engine (Over Head Valve Engine, hereinafter called “engine”) 24 (which will be described later) according to a preferred embodiment of the present invention. In the present specification, a “fore-aft direction” and a “left-right direction” in the engine generator 10 are defined as shown in FIG. 1 and FIG. 2 for the sake of descriptive convenience. Thus, a side on which the engine 24 is provided is a “front side”, a side on which a generator 26 (to be described later) is provided is a “rear side”, and a side on which an operation panel 48 (to be described later) is provided is a “left side”.

The engine generator 10 preferably is a portable generator, including a generator frame 12. The generator frame 12 includes a front frame 14, a rear frame 16, an upper frame 18, and a pair of lower frames 20, 22. The front frame 14 is provided by a pipe-shaped member which is preferably formed into a general shape of inverted letter of U in a front view, whereas the rear frame 16 is provided by a pipe-shaped member which is preferably formed into a general shape of inverted letter of U in a rear view. The front frame 14 and the rear frame 16 are connected with each other at both of their end portions. The upper frame 18 is provided by a pipe-shaped member and extends in the fore-aft direction, connecting upper left end portions of the front frame 14 and the rear frame 16, respectively. The upper frame 18 defines and serves as a grip. The lower frame 20 is a platy member extending in the left-right direction, connecting left and right lower portions of the front frame 14 with each other. The lower frame 22 is a platy member extending in the left-right direction, connecting left and right lower portions of the rear frame 16 with each other.

The engine 24 is installed on the lower frame 20, whereas the generator 26 is installed on the lower frame 22. The engine 24 and the generator 26 are arranged in the fore-aft direction, with the engine 24 being on the front side and the generator 26 being on the rear side. The engine 24 includes a crank shaft 66 (to be described later), which is connected with a rotating shaft (not illustrated) of the generator 26.

The engine 24 includes, on its front side, an air intake section 28 to introduce outside air. The air intake section 28 includes a cooling fan (not illustrated). An air cleaner 30 is provided on the right side of the air intake section 28. As the cooling fan is driven, outside air introduced from the air intake section 28 cools the engine 24. Near the air intake section 28, a recoil starter 32 is provided.

A muffler 34 is provided behind the engine 24, on the right side of the generator 26. Exhaust gas from the engine 24 is discharged to outside via the muffler 34. A canister 36 is provided below the engine 24. A fuel tank 38 is connected to the air cleaner 30 via the canister 36. Gasoline vapor from the fuel tank 38 is adsorbed in the canister 36.

The fuel tank 38 is arranged to cover the engine 24 and the generator 26 from above. The fuel tank 38 stores fuel (for example, gasoline, in the present preferred embodiment) which is to be supplied to the engine 24. The fuel tank 38 has its right side portion attached to a support frame 40 which connects an upper right end portion of the front frame 14 and an upper right end portion of the rear frame 16 to each other. The fuel tank 38 has its left front portion and left rear portion connected to the front frame 14 and the rear frame 16 respectively via brackets 42 and 44.

An operation box 46 is provided on the left side of the fuel tank 38. The operation box 46 includes the operation panel 48, and a case 50 which is provided on the right side of the operation panel 48 and incorporates an operation section (not illustrated), etc. A battery 52 is provided below the case 50.

In the engine generator 10 described as above, the recoil starter 32 is pulled to rotate the crank shaft 66 and start the engine 24. As the engine 24 starts, the generator 26 starts its power generating operation. The electric power from the generator 26 can be taken out of the operation panel 48 or stored in the battery 52.

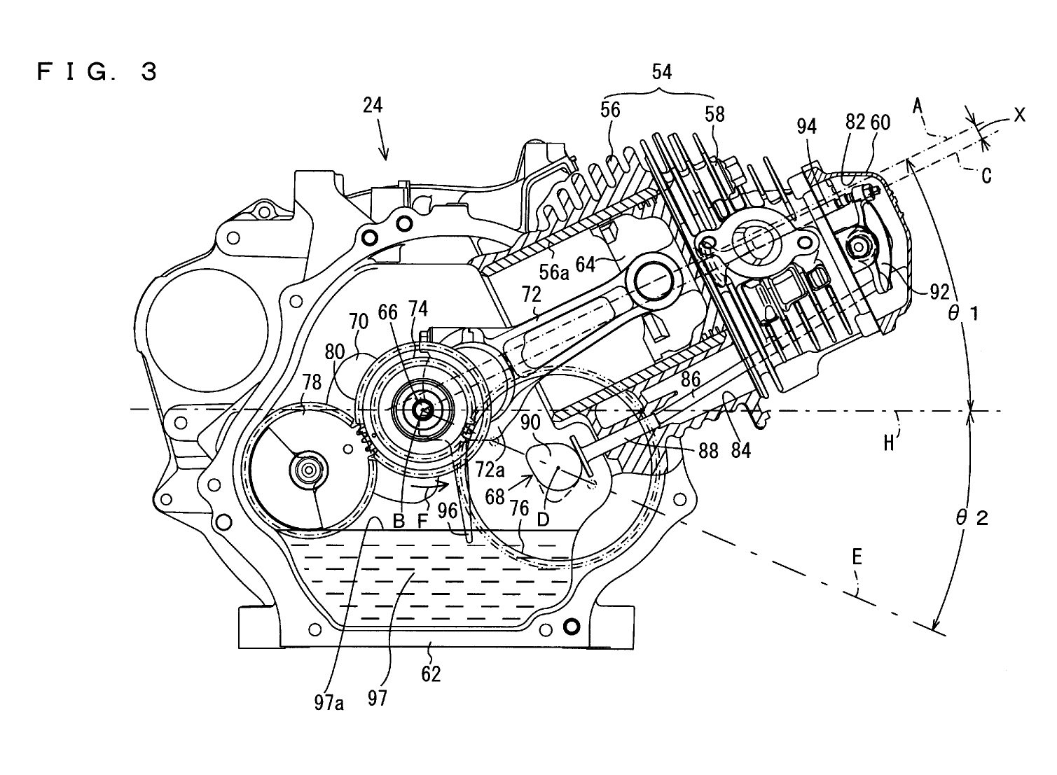

Reference will now be made to FIG. 3 to describe the engine 24.

The engine 24 preferably is an air-cooled, single-cylinder, four-cycle engine for example, of a slanted type in which a cylinder center axis A is slanted obliquely. The engine 24 includes a cylinder 54. The cylinder 54 includes a cylinder body 56 and a cylinder head 58 which is attached to an upper end portion of the cylinder body 56. A cylinder head cover 60 is attached to an upper end portion of the cylinder head 58. A crank case 62 is provided in a lower portion of the cylinder body 56.

The cylinder body 56 has an inner circumferential surface provided with a cylinder liner 56a. Inside the cylinder body 56, a piston 64 is provided slidably with respect to the cylinder liner 56a. The crank case 62 accommodates the crank shaft 66 and a camshaft 68 which moves in association with the crank shaft 66. The crank shaft 66 is disposed horizontally. The crank shaft 66 and the cam shaft 68 are parallel or substantially parallel to each other. The camshaft 68 is disposed not to interfere (contact) with crank webs 70 of the crank shaft 66. The piston 64 and the crank shaft 66 are connected to each other by a connecting rod 72, such that reciprocating movement of the piston 64 is converted into rotating movement by the crank shaft 66. The crank shaft 66 is provided with a drive gear 74, whereas the cam shaft 68 is provided with a driven gear 76 which rotates in association with rotation of the drive gear 74. The crank case 62 also accommodates a balancer 78. The balancer 78 is in engagement with a gear 80 provided in the crank shaft 66, to reduce vibration.

From the cylinder body 56 to the cylinder head 58, there is provided a communication path 84 which provides communication between inside of the crank case 62 and inside of a rocker arm chamber 82 in the cylinder head cover 60. A pushrod 86, and a tappet 88 provided on an end portion of the pushrod 86 are inserted through the communication path 84. Inside the crank case 62, the tappet 88 has its tip portion contacted to a cam 90 of the cam shaft 68. The pushrod 86 has another end portion contacted to a rocker arm 92 which is provided inside the rocker arm chamber 82. The rocker arm 92 drives an exhaust valve 94. Additionally, though not illustrated in FIG. 3, the engine 24 accommodates a pushrod, a tappet and a rocker arm for driving an inlet valve, in parallel or substantially in parallel to the pushrod 86, the tappet 88 and the rocker arm 92 to drive the exhaust valve 94.

An oil dipper 96 is attached to a big end portion 72a of the connecting rod 72, and oil 97 is stored inside the crank case 62. The oil 97 is splashed by the oil dipper 96 to the cylinder body 56, the cylinder head 58, the cylinder head cover 60 and so on, directly or indirectly after spattering on the crank shaft 66, the cam shaft 68, etc., such that lubrication of the crank shaft 66, the cam shaft 68, the cylinder body 56, the rocker arm 92, etc. is achieved.

With the above-described arrangement, the cylinder body 56 is inclined in an obliquely upward direction so that the cylinder center axis A and a horizontal plane H define an angle θ1 which is greater than 0 degree and smaller than about 45 degrees, for example, when the cylinder body 56 is viewed from the crank shaft 66. The cam shaft 68 is at a lower position than the cylinder center axis A. The cylinder center axis A is offset with respect to a line C which passes through a rotation axis B of the crank shaft 66 and is parallel or substantially parallel to the cylinder center axis A, by a distance X to a side away from the cam shaft 68. The horizontal plane H is a plane that is parallel or substantially parallel to a liquid surface 97a of the oil 97 stored in the crank case 62. FIG. 3 shows a horizontal plane H which passes through the rotation axis B of the crank shaft 66.

The cam shaft 68 has its rotation axis D at a lower height than the horizontal plane H which passes through the rotation axis B of the crank shaft 66. A straight line E which connects the rotation axis D of the cam shaft 68 and the rotation axis B of the crank shaft 66 with each other defines an angle θ2 with the horizontal plane H, and the angle θ2 is greater than 0 degree and smaller than about 45 degrees, for example. It is preferable that the angle θ1 is greater than the angle θ2.

Further, as shown in FIG. 3, when the engine 24 is viewed from a position where the crank shaft 66 is located on the left side and the camshaft 68 is located on the right side, a rotation direction of the crank shaft 66 is counterclockwise as indicated by Arrow F.

According to the engine 24 as has been described thus far, it is possible to increase a distance between the cylinder body 56 and the cam shaft 68 by offsetting the cylinder center axis A to the side away from the cam shaft 68. Thus, it is possible to achieve more inclination in the cylinder body 56 without changing a distance between the cam shaft 68 and the crank shaft 66 (distance between the rotation axis D of the cam shaft 68 and the rotation axis B of the crank shaft 66) within a range where there is no interference between the cylinder body 56 and the cam shaft 68. Consequently, it is possible to lower the height of the engine 24 within this range. Further, the cylinder body 56 inclines within the condition that the angle θ1 which is defined by the cylinder center axis A and the horizontal plane H is greater than 0 degree and smaller than about 45 degrees, for example. Therefore, even when the cylinder body 56 is given a longer dimension in the direction of the cylinder center axis A, an increase in the height of the engine 24 is smaller than an increase in the horizontal dimensions of the engine 24. As a result, it becomes possible to reduce the increase in the height of the engine 24 even if the length of the cylinder body 56 is increased.

When increasing the piston stroke generally in an OHV engine, the crank webs have to have an increased outward form, and therefore the cam shaft must be moved away from the crank shaft in order to prevent interference with the crank webs. This results in an increase in the distance between the rotation axis of the cam shaft and the rotation axis of the crank shaft, and an increase in a diameter (radius) of the cam shaft driven gear, so the cam shaft driven gear is dipped in oil inside the crank case to an increased height (depth). If the driven gear is dipped into the oil to an increased height (depth) when splashing the oil, more horse power is lost. According to the engine 24, however, the angle θ2 which is defined by the horizontal plane H and the straight line E that connects the rotation axis D of the cam shaft 68 and the rotation axis B of the crank shaft 66 with each other preferably is greater than 0 degree and smaller than about 45 degrees, for example. Due to this arrangement, even when the distance between the rotation axis D of the cam shaft 68 and the rotation axis B of the crank shaft 66 is increased, an increase in the vertical distance is smaller than an increase in the horizontal distance. Because of this, and due to the fact that the horizontal plane H is in parallel or substantially parallel to the liquid surface 97a of the oil 97, the arrangement makes it possible to significantly reduce or prevent an increase in a surface area of the portion of the driven gear 76 in the cam shaft 68 that is dipped into the oil 97, and therefore makes it possible to significantly reduce or prevent an increase in loss of horse power. In addition, the arrangement also significantly reduces or prevents an increase in the height of the engine 24. Further, if the distance X from the line C which is parallel or substantially parallel to the cylinder center axis A is increased without moving the rotation axis B of the crank shaft 66 to a higher position, it becomes possible to decrease the distance between the rotation axis D of the cam shaft 68 and the rotation axis B of the crank shaft 66 while significantly reducing or preventing an increase in the height of the engine 24, and therefore it becomes possible to also decrease the diameter (radius) of the driven gear 76 of the cam shaft 68 to an extent that the driven gear 76 of the cam shaft 68 does not have its lower end contacting the liquid surface 97a of the oil 97. The arrangement described above significantly reduces or prevents loss of horse power.

In the engine 24, location of the cam shaft 68 is limited so that the angle θ2 is smaller than the angle θ1, whereas the rotation axis D of the cam shaft 68 is disposed at a higher position, i.e., more closely to the horizontal plane H which passes through the rotation axis B of the crank shaft 66. The cam shaft 68 disposed at the higher position allows to increase the distance between the cam shaft 68 and the liquid surface 97a of the oil 97 inside the crank case 62, which then makes it possible to raise the liquid surface of the oil 97 (closer to the horizontal plane H which passes through the rotation axis B of the crank shaft 66). Consequently, it becomes possible to reduce a dimension of the crank case 62 in the up-down direction. As a result, it becomes possible to reduce the dimension of the engine 24 in the up-down direction, i.e., the height of the engine 24.

Generally in an OHV engine, a maximum combustion pressure is reached slightly after the piston has passed the top dead center. At this point, the combustion pressure in a space surrounded by the cylinder body and the piston peaks out, with the piston under an increased thrust force. According to the engine 24, as described earlier, the cylinder center axis A preferably is offset to the side spaced away from the cam shaft 68 and the crank shaft 66 is rotated counterclockwise (as indicated by Arrow F in FIG. 3). This arrangement makes it possible to bring the connecting rod 72 (especially the center of the big end portion 72a) closely to the cylinder center axis A slightly after the piston 64 has passed the top dead center. Specifically, during the time when the combustion pressure is high, the connecting rod 72 and the cylinder body 56 are in a positional relationship which advantageously reduces a thrust force that acts on the piston 64. This reduces friction which acts on the piston 64, and thus improves fuel economy.

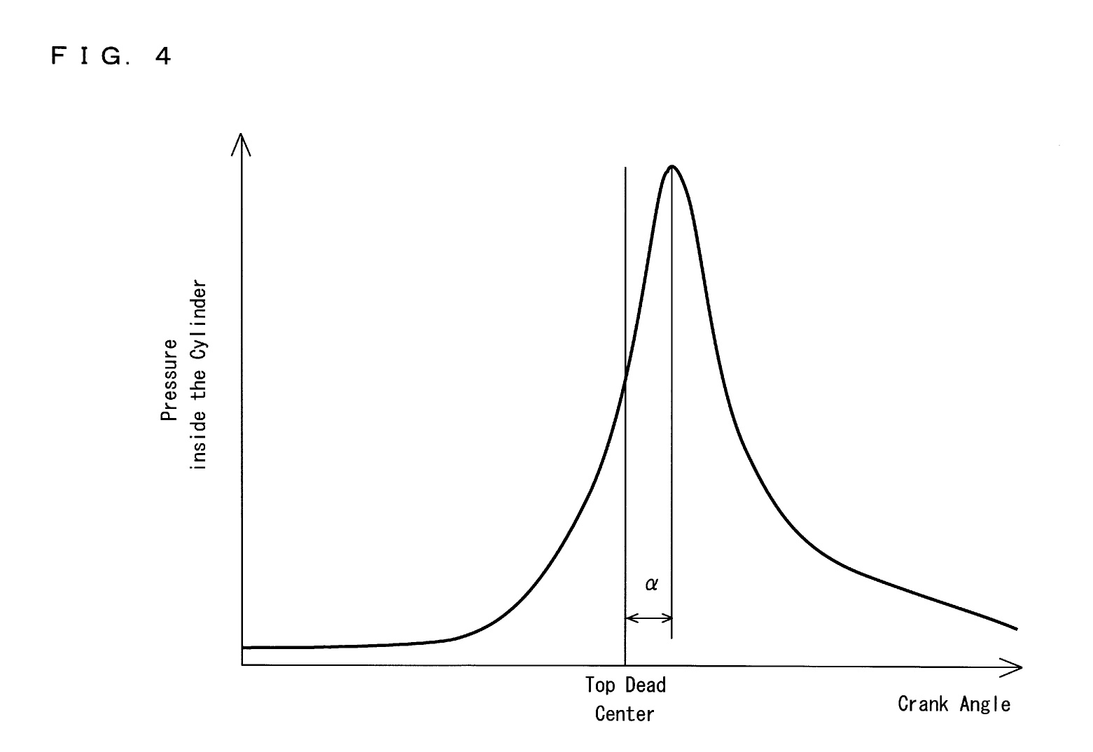

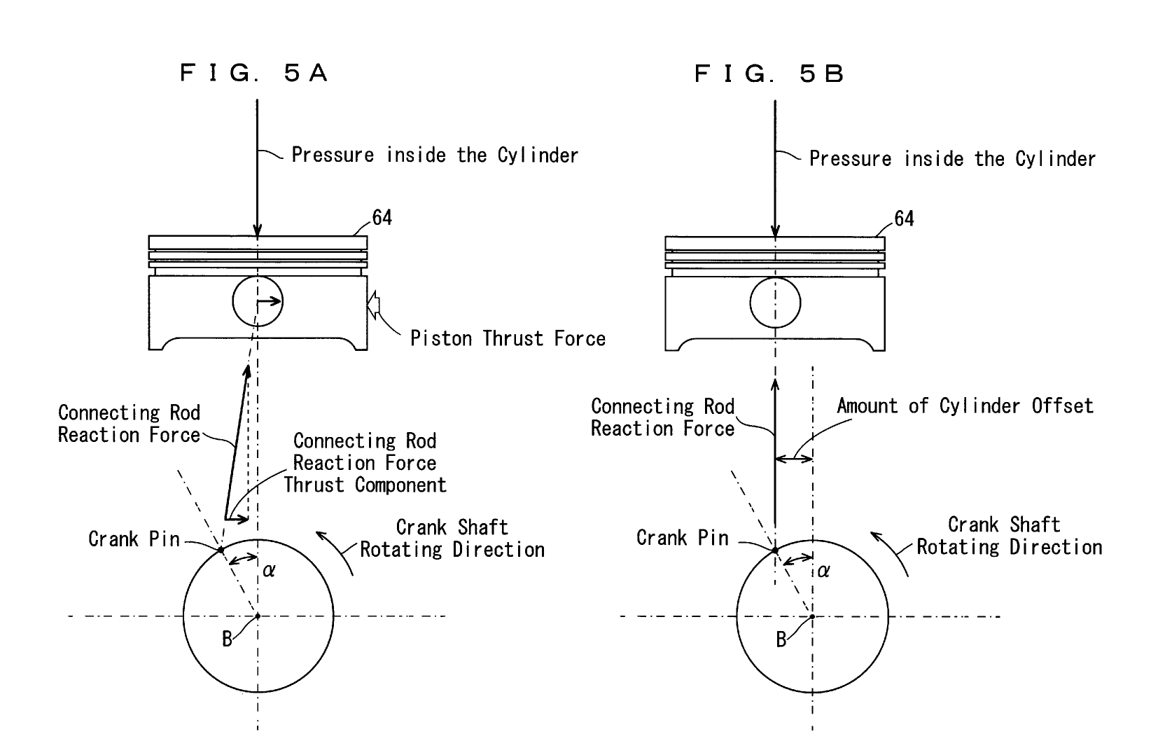

This will be elaborated with reference to FIG. 4, FIG. 5A and FIG. 5B.

In the engine 24, a combustion pressure (pressure inside the cylinder) which acts on the piston 64 rotates the crank shaft 66 via the connecting rod 72. Although an ignition occurs before the piston 64 reaches the top dead center, combustion takes a certain amount of time, and as shown in FIG. 4, the pressure inside the cylinder is reached to its peak after the top dead center is reached. Here, an angle difference a will be defined as a difference between a crank angle when the piston 64 is at the top dead center and a crank angle when the pressure inside the cylinder is at its peak.

With reference to FIG. 5A, if there is no cylinder offset, a connecting rod reaction force has a thrust component as a function of the angle difference a, and this thrust force acts on the piston 64. In this case, there is a large friction force generated between the piston 64 and the cylinder 54, which causes a friction loss.

In FIG. 5B, on the other hand, when the pressure inside the cylinder is around its peak, the connecting rod 72 has its longitudinal axis (a straight line which passes through a connecting section between the connecting rod 72 and the piston 64, and a connecting section between the connecting rod 72 and the crank shaft 66), in or substantially in alignment with the cylinder center axis A or in parallel or substantially in parallel thereto, so a connecting rod reaction force has zero or a small thrust component due to the amount of offset of the cylinder 54. This decreases the friction force and the friction loss between the piston 64 and the cylinder 54.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An OHV engine comprising:
a cylinder;
a piston inside the cylinder;
a crank shaft configured to convert reciprocating movement of the piston into rotating movement;
a connecting rod configured to connect the piston and the crank shaft to each other; and
a cam shaft configured to move in association with the crank shaft; wherein
the cylinder is inclined in an obliquely upward direction at an angle θ1 defined by a cylinder center axis and a horizontal plane being greater than 0 degree and smaller than about 45 degrees when the cylinder is viewed from the crank shaft;
the cam shaft is at a lower position than the cylinder center axis; and
the cylinder center axis is offset with respect to a line passing through a rotation axis of the crank shaft and is parallel or substantially parallel to the cylinder center axis, to a side spaced away from the cam shaft.

2. The OHV engine according to claim 1, further comprising:
a crank case attached to the cylinder and accommodating the crank shaft and the cam shaft;
a drive gear provided around the crank shaft; and
a driven gear provided around the cam shaft and rotating in association with rotation of the drive gear; wherein
the cam shaft has its rotation axis at a lower position than a horizontal plane which passes through the rotation axis of the crank shaft; and
the horizontal plane and a straight line which connects the rotation axis of the cam shaft and the rotation axis of the crank shaft define an angle θ2 which is greater than 0 degree and smaller than about 45 degrees.

3. The OHV engine according to claim 2, wherein the angle θ1 is greater than the angle θ2.

4. The OHV engine according to claim 1, wherein a rotation direction of the crank shaft is counterclockwise when the OHV engine is viewed from a position where the crank shaft is located on the left side and the cam shaft is located on the right side.
